(19) United States
(12) Patent Application Publication
(10) Pub. No.: US 2008/0049605 A1
(43) Pub. Date: Feb. 28, 2008

(54) Out of sight light

(76) Inventor: John M. Balger, Portsmouth, NH (US)

Correspondence Address: JOHN M. BALGER, P.O. BOX 12, PORTSMOUTH, NH, 03801-3850, US

(21) Appl. No.: 11/507,249

(22) Filed: Aug. 22, 2006

(51) Int. Cl. H04L 5/04

(52) U.S. Cl. 370/211

(57) ABSTRACT

“The Out of Sight Light” is a mechanism, which can elevate itself through the use of air pressure, in the base unit being contained by the use of multiple O-rings and lower itself through the use of a spring expanding; which becomes compressed as the cylinder elevates out of the base unit. It has a lens, which can be easily changed for the use of colored filters; through the use of threaded connections. It is also protected due to the fact that when not in use, the extension cylinder which houses the light emitting element and filter; lowers back into its original position inside the base unit. It maintains vertical stability through the use of multiple O-rings, one of which also keeps debris from accumulating inside the base unit.

### BACKGROUND OF THE INVENTION

Landscape lights are fixed stationary objects installed in the ground and rising above ground level with a light fixture placed in the top of the unit or relatively close to the top for the purpose of light distribution for the surrounding area. The problem I find with these kind of lights which are used typically at night and not during the daylight hours is that they are an obstacle to be avoided during the day when not in use. This is a serious problem during the daylight hours when not being used for light distribution. I've noticed lawn mowers, weed trimmers, and other moving objects easily destroy these units due to the fact that they are stationary. This is a flaw in a stationary landscape light (which is only needed at night). My invention eliminates the flaw of traditional landscape lighting.

### BRIEF SUMMARY OF INVENTION

My invention of “The Out of Sight Light” is an advance in landscape lighting technology, while also being simplistic in form. The invention uses air pressure or any substances that can increase pressure inside the base unit and through the use of increased pressure raise a cylinder, which fits inside the base unit. Multiple stages can also be used to raise multiple cylinders to reach a greater height than that of the dimension of the base unit length. O-rings or similar type sleeves are used to contain the increasing pressure while traveling along the inner cylinder wall of the base cylinder, or cylinders; if multiple cylinders are being used. My invention uses cylinders in the drawings but the invention could also use other shaped shafts such as square, hexagon, or any other shape which can fit inside the base unit in such a way where the raising process can still take place. As the cylinder or other shaped shaft rises out of the base unit, springs contained inside the walls of the base unit and around the rising cylinder or other shaped shaft outer walls begin to compress from an uncompressed state. As the inner cylinder or other shaped shaft travels to full extension, the springs become fully compressed. When the pressure inside the base unit is removed, the compressed spring or springs (if using multiple cylinders or other shaped shafts) begin to expand back to their original uncompressed state, while lowering the raised cylinder, cylinders; or other shaped shaft or shafts back inside the base unit. The advantage of this invention is that it raises and lowers the cylinder or other shaped shafts back into the base unit, through whatever means is most suitable for raising and lowering, (not just through increased pressure from within the base unit). The advantages of this raising and lowering light is that it is out of sight and out of the way of lawn mowers, weed trimmers, or any moving object, person, or animal during the day.

### BRIEF DESCRIPTION OF SEVERAL VIEWS OF THE DRAWING

FIG. 1-A Top Cover

FIG. 1-B Extension Cylinder Lens

FIG. 1-C Extension Cylinder

FIG. 1-D Extension Cylinder O-Ring

FIG. 1-E Compression Spring

FIG. 1-F Light Housing Section

FIG. 2-A Base Unit

FIG. 2-B Base Unit Top

FIG. 2-C Base Unit Top O-Ring

FIG. 2-D Base Unit Compression Inlet/Outlet Flanged Nozzle

FIG. 2-E Base Unit Electrical Connector

### DETAILED DESCRIPTION OF THE INVENTION

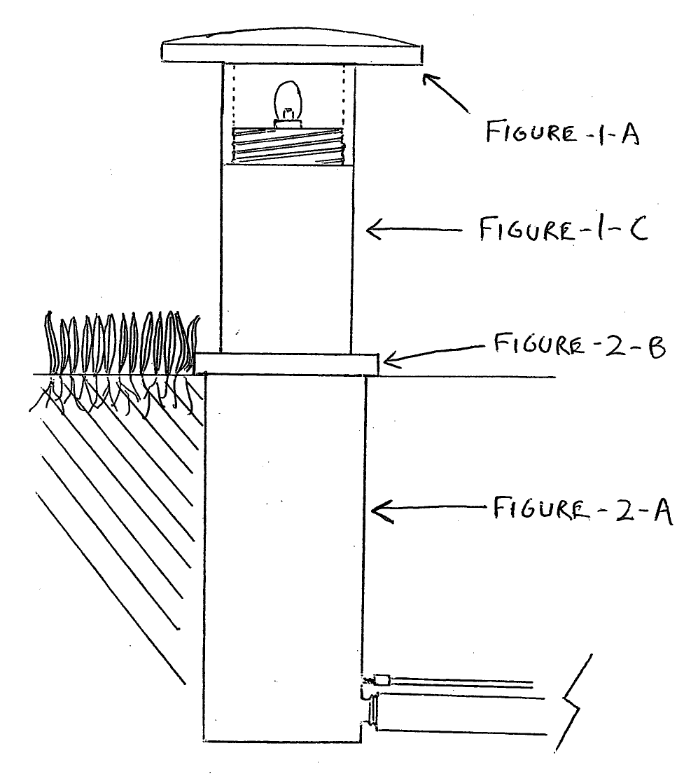

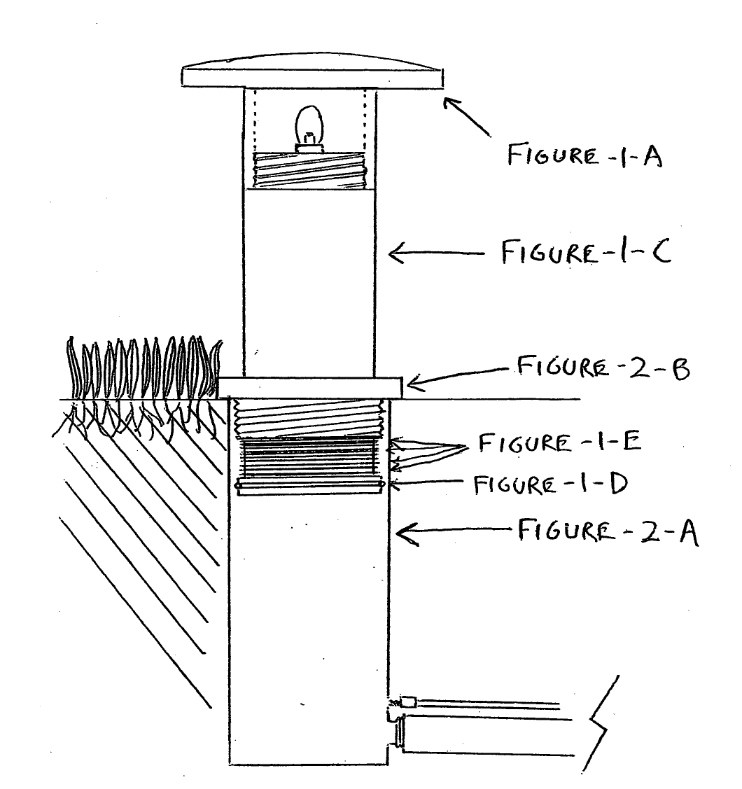

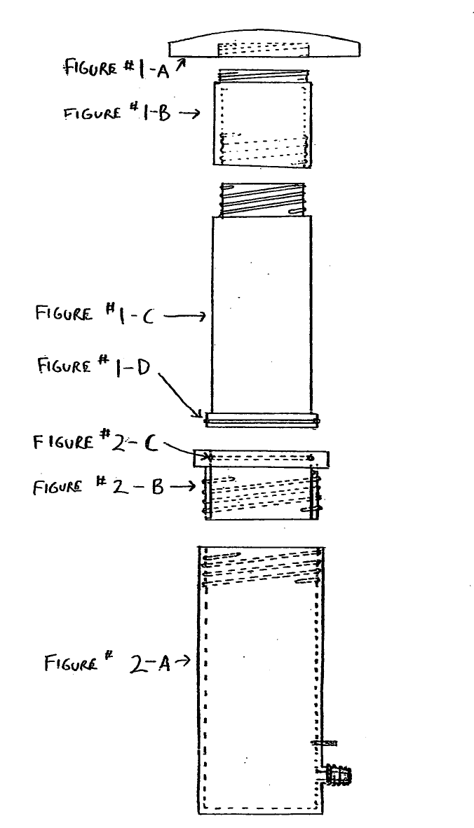

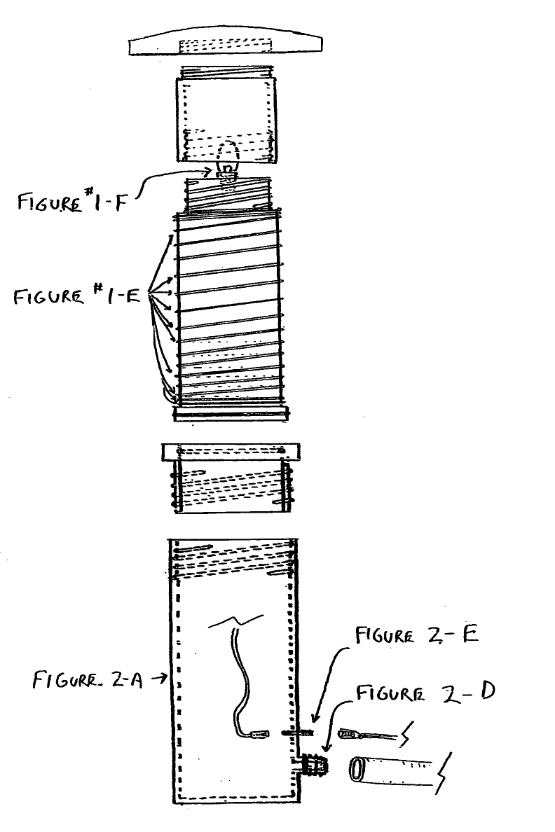

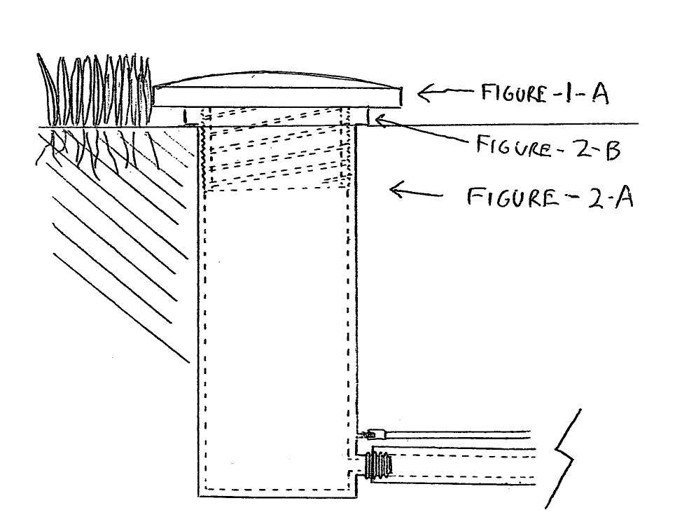

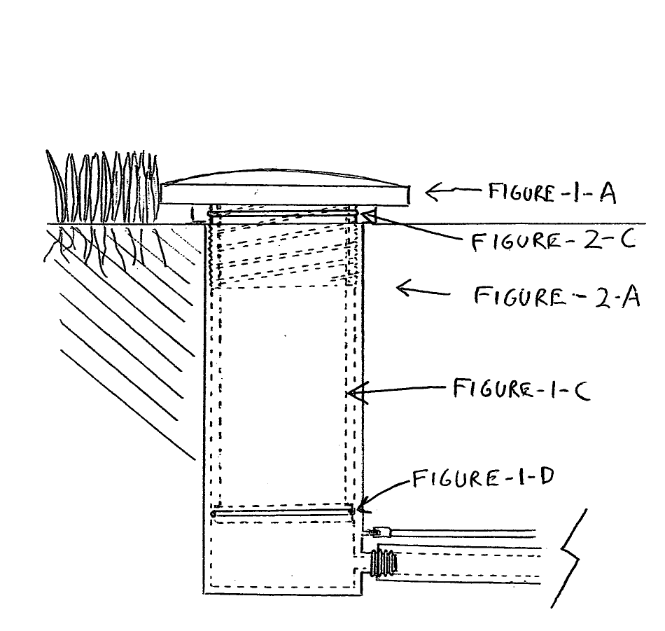

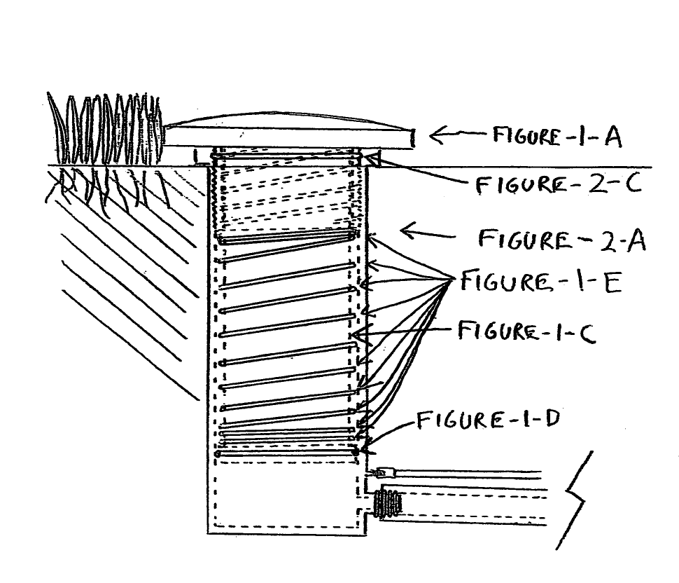

My invention of “The Out of Sight Light” is totally unique and simple in its design elements. It is nothing more than an extension cylinder (FIG. 1-C) that is placed inside the base unit (FIG. 2-A) which has a cylindrical inner diameter slightly larger than the extension cylinder (FIG. 1-C) bottom outer diameter. With the use of an O-ring (FIG. 1-D) placed on the bottom of the extension cylinder (FIG. 1-C) to retain pressure. The base unit (FIG. 2-A) when filled with compressed air or any substance which increases pressure inside the base unit (FIG. 2-A) through the base unit compression inlet/outlet flanged nozzle (FIG. 2-D) starts to elevate the extension cylinder (FIG. 1-C) until it reaches full extension. Full extension is reached when the compression spring (FIG. 1-E) becomes fully compressed. The compression spring (FIG. 1-E) is compressed between the bottom of the extension cylinder (FIG. 1-C), on the top of the lateral edge above the extension cylinder O-ring (FIG. 1-D) and the bottom edge of the base unit top (FIG. 2-B). When pressure is removed from the base unit (FIG. 2-A) through the base unit compression inlet/outlet flanged nozzle (FIG. 2-D), the compression spring (FIG. 1-E), expands back to its “fully uncompressed” state (FIG. 1-E). As a result the extension cylinder (FIG. 1-C) returns to its original position back inside the base unit (FIG. 2-A). Electrical power to the light housing section (FIG. 1-F) is delivered through the use of a shielded electrical wire. The wire length is slightly longer than the length of the extension cylinder (FIG. 1-C) at full extension. The wire is then connected to the base unit electrical connector (FIG. 2-E) on the inside of the base unit (FIG. 2-A) and then connects to the light housing section on the extension cylinder (FIG. 1-F). The outside electrical connection to the base unit electrical connector (FIG. 2-E) is the point where the electrical wire leading from the lighting system transformer would be connected.

### Suggested Materials for Construction of the Invention

The base unit (FIG. 2-A) is molded plastic or any hard substance which can be manufactured. The top of the inner diameter of the base unit (FIG. 2-A) has threads so the base unit top (FIG. 2-B) can be screwed into place, through the use of threads on the outer diameter of the base unit top (FIG. 2-B). The base unit top (FIG. 2-C) also has an O-ring (FIG. 2-C) placed inside the inner diameter, just below of the base unit top to help keep foreign matter from traveling into the base unit (FIG. 2-A). Please note that: the base unit (FIG. 2-A) and the base unit top (FIG. 2-B) and the extension cylinder (FIG. 1-C) and also the top cover (FIG. 3-A), are all to be constructed of the same materials; but not limited to the same materials as in such a case where different design elements are preferred for visual effect of the invention during manufacturing.

The base unit (FIG. 2-A) has a cylindrical inner shape for the specific ability to be used as a piston type function for the raising and lowering of the extension cylinder. Please note that other shapes as previously mentioned in the brief summary can also be used to achieve this raising and lowering action but they would require a different type of sleeve than an O-ring (to retain pressure due to non-circular shape, but it could be achieved). Please also note, the method would remain the same, due to the fact that pressure raises the extension shaft. The use of a compression spring would also remain as the primary mechanism used to lower the shaft when the base unit pressure is removed, lowering the shaft back into its original position in the base unit. Side note: Electrical servo motors, electromagnetics, and any other form of raising and lowering could also be substituted.”

### Assembly and Suggested Materials for “The Out of Sight Light”

The compression spring (FIG. 1-E) is placed over the extension cylinder (FIG. 1-C) from the top of the unit until it rests on the bottom of the extension cylinder. The O-ring (FIG. 1-D) is placed in the groove for the O-ring on the bottom of the extension cylinder (FIG. 1-C). The light bulb (or other light emitting device) is connected to the light housing section (FIG. 1-F). The extension cylinder lens (FIG. 1-B) is screwed into place on top of the extension cylinder (FIG. 1-C). Electrical wires are connected as previously described on page 4, line 13 of this document. The partially assembled extension cylinder is placed inside the base unit (FIG. 2-A). The base unit top O-ring (FIG. 2-C) is put in the O-ring groove on the top inside section of the base unit top (FIG. 2-B). The base unit top (FIG. 2-B) with its O-ring in place is screwed into the threaded section of the base unit (FIG. 2-A) to form an airtight seal. The top cover (FIG. 1-A) is screwed into place on the threaded top of the extension cylinder lens (FIG. 1-B). The air line is connected to the base unit compression inlet/outlet flanged nozzle (FIG. 2-D). The extension cylinder (FIG. 1-C) has threads on the top section for attaching removable lens (FIG. 1-B). The extension cylinder (FIG. 1-C) has a groove on the bottom part of the cylinder for attaching the O-ring (FIG. 1-3). The diameter of the bottom of the extension cylinder (FIG. 1-3) is slightly larger than the main body of the cylinder, for the purpose of having an edge or shelf for the compression spring (FIG. 1-E) to rest on. The shelf is needed for resistance to compress the compression spring (FIG. 1-E). When the extension cylinder (FIG. 1-C) is fully extended, the vertical stability of the extension cylinder (FIG. 1-C) is maintained through the use of both O-rings, [O-ring (FIG. 1-D) and O-ring (FIG. 2-C)]. This keeps the extension cylinder (FIG. 1-C) from leaning out of plum (vertical level) from the base unit (FIG. 2-A). The extension cylinder lens (FIG. 1-B) is made of clear plastic or any desired color. The extension cylinder lens (FIG. 1-B) can also be made from glass or any other material desired. Although, I believe that plastic is the most efficient material. The extension cylinder lens (FIG. 1-B) has threads on the inner diameter of the lower section to attach to the extension cylinder (FIG. 1-C). The extension cylinder lens (FIG. 1-B) also has threads on the top section for attaching the top cover (FIG. 1-A). The use of threads on the top and bottom of the extension cylinder lens (FIG. 1-B) allows for the ability to interchange lens if desired. The top cover (FIG. 1-A) has threads in the bottom section so it can be screwed onto the top of the extension cylinder lens. The electric wire leading from the transformer to the base unit (FIG. 2-E) is connected to the base unit electrical connector (FIG. 2-E).

The invention is now fully assembled and ready for installation. The grade level of the base unit (FIG. 2-A) should be at the exact point where the top of the base unit (FIG. 2-A) meets the bottom over hanging edge on the base unit top (FIG. 2-B).

I claim:

1. “The Out of Sight Light” can raise out of its base unit when needed to be used for lighting purposes, through the use of increasing air pressure inside the base unit, which is contained through the use of multiple O-rings.

2. “The Out of Sight Light” can lower itself back into the base unit when not in use, through the use of a compression spring, (which is in a compressed state when the extension cylinder is fully extended). The spring expands back to its uncompressed state as a result of the air pressure being decreased from inside the base unit which lowers the extension shaft back into the base unit.

3. “The Out of Sight Light” retains its vertical stability through the use of multiple O-rings placed apart from each other in both the elevated (raised) and lowered state inside the base unit.
